(19) United States
(12) Patent Application Publication
(10) Pub. No.: US 2010/0018592 A1
(43) Pub. Date: Jan. 28, 2010

(54) Fluid control system for precisely controlling a flow of fluid

(76) Inventor: Frederick A. Parker, Gwynedd Valley, PA (US)

Correspondence Address: BACON & THOMAS, PLLC, 625 SLATERS LANE, FOURTH FLOOR, ALEXANDRIA, VA, 22314-1176, US

(21) Appl. No.: 12/385,799

(22) Filed: Apr. 20, 2009

Related U.S. Application Data
(63) Continuation of application No. 10/681,748, filed on Oct. 9, 2003, now abandoned.

(51) Int. Cl. F16K 31/02

(52) U.S. Cl. 137/487.5

(57) ABSTRACT

A fluid flow control system for precisely controlling fluid flow from a source of fluid under pressure. A flow path for coupling said source of fluid to a point of utilization includes a valve and a flow restrictor. A pressure transducer is connected across the flow restrictor for measuring the pressure differential thereacross and producing a signal proportional to the pressure differential, and a controller is connected to receive said signal and pulse said valve at a frequency to obtain a preset target value of pressure across said flow restrictor. A system of mixing two or more fluid streams comprising in combination one or more flow control systems are defined above and a mixer coupled to each of said fluids is coupled to the point of utilization.

### REFERENCE TO RELATED APPLICATION

The present invention is the subject of provisional application Ser. No. 60/417,565 filed Oct. 11, 2002 entitled SYSTEM AND METHOD OF PRECISELY MIXING TWO (OR MORE) FLUID STREAMS; GAS OR LIQUID.

### BACKGROUND AND BRIEF DESCRIPTION OF THE INVENTION

The present invention in the field of fluid flow controls, and more particularly within the field of fluid flow controls for precisely mixing two or more fluid streams (gas or liquid). Fluid flow control systems for controlling the fluid flow from a source of fluid under pressure to a point for mixing with another fluid are well known in the art. Such systems are costly and cumbersome and in some instances not precise enough for particular applications.

An object of the present invention is to provide a fluid flow control system which precisely controls the fluid flow from a source of fluid under pressure. More particularly, an object of the invention is to provide a fluid flow control system for precisely mixing two or more fluid streams whether they be gas or liquid.

According to the invention, a fluid flow control system for precisely controlling fluid flow from a source of fluid under pressure to a point of utilization comprises a control valve capable of high frequency pulse operation and a flow restrictor positioned in the flow path. A pressure transducer is connected across the flow restrictor for measuring the pressure differential thereacross and producing a voltage signal proportional to the pressure differential. An electrical controller is connected to receive the voltage signal and pulse the valve at a frequency to obtain a preset target value of pressure across the flow restrictor. When the system is used for mixing two or more fluid streams, a mixer coupled to the first flow is also coupled to a second fluid (which may be controlled in the same manner). The mixer is then coupled to the point of utilization. Any number of gases or fluids or mixtures of gases and fluids may be controlled by the invention disclosed herein and mixed together. The invention can be used to control or mix liquid or gas with other liquids or gases controlled by the same or other means. Moreover, an auxiliary input can be programmed to compensate for changes in flows of fluid in order to maintain the same mixing ratio.

### DESCRIPTION OF THE DRAWINGS

The above and other objects, advantages and features of the invention will become more apparent when considered with the following specification and accompanying drawings wherein:

FIG. 1 is a schematic illustration of a fluid flow control system incorporating the invention,

FIG. 2 is a graph showing the flow plotted against the pressure drop across the flow restrictor or voltage output of the pressure transducer, and

FIG. 3 illustrates a further embodiment.

### DETAILED DESCRIPTION OF THE INVENTION

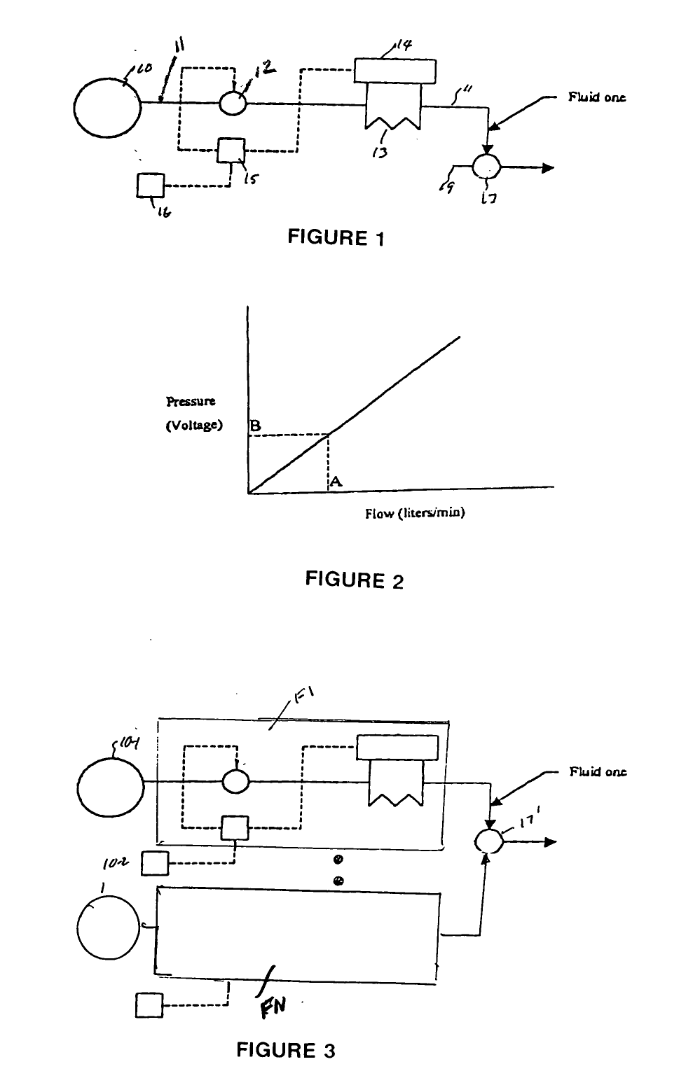

Referring to FIGS. 1 and 2 of the drawings a reasonably regulated pressure source of a fluid 10 is coupled by a flow path 11 to a mixer 17. Mixer 17 is coupled to a source of a second fluid 19 which is the fluid with which fluid 10 is mixed. Flow path 11 includes a valve 12 which is pulsed at a rate to obtain a desired flow volume. The flow path 11 includes a flow restrictor 13 and a pressure transducer 14 connected to measure or sense the pressure differential or drop across flow restrictor 13 and produces a voltage signal proportional thereto. The voltage signal supplied to controller 15 is converted thereby to a pulse signal to drive valve 12 at a frequency or rate to obtain a preset target value of pressure across the flow restrictor, and thereby control the flow rate of fluid 10. FIG. 2 illustrates the relationship between the fluid flow rate through the flow restrictor 13 and the voltage output of the pressure transducer 14. A linear relationship is shown but it can be any repeatable relationship between flow and pressure.

In operation, if it is desired to control the flow rate of fluid 10 to the value designed A (shown by the dotted line in FIG. 2), the electronic controller 15 would pulse the valve 12 at the frequency required to obtain pressure (voltage) (B) in FIG. 2 across the pressure transducer.

Additional inputs may be required for certain applications. For example, if due to a significant change in temperature or pressure the fluid properties, such as that viscosity or density change appreciably, a correction or flow modifying factor can be entered into the electronic frequency controller 15 by an auxiliary input device shown in FIG. 1 as component 16.

In the embodiment shown in FIG. 3, each flowpath F₁ . . . F_{N} may have the same components as in FIG. 1 and operate in the same manner, or the flow in the other flow paths may be controlled by other means. The electronic controller 15 can be utilized for all of the flow paths F₁ . . . F_{N} and can be combined or integrated as one unit.

The controller may also be programmed so that if the flow in one of the flow paths changes the other flow(s) can be adjusted to compensate and thereby maintain the same mixing ratio.

The invention is of course applicable where no mixing of fluid is involved and one may only wish to control the mass or volume of flow of a single fluid.

Another feature of the invention is that the fluid flow control memo shown automatically compensates for various other changes that may occur in a fluid flow circuit. For example, were a change in backpressure to occur, or a change in source pressure, the system would compensate by automatically changing the pulse frequency and thereby maintain the desired voltage output from the pressure transducer and thereby the desired flow.

While the invention has been described in relation to preferred embodiments of the invention, it will be appreciated that other embodiments, adaptations and modifications of the invention will be apparent to those skilled in the art.

What is claimed is:

1. A fluid flow control system for precisely controlling fluid flow from a source of fluid under pressure,
a flow path for coupling said source of fluid to a point of utilization,
a valve in said flow path,
a flow restrictor in said flow path,
a pressure transducer connected across said flow restrictor for measuring the pressure differential thereacross and producing a signal proportional to said pressure differential, and
a controller connected to receive said signal and pulse said valve at a frequency to obtain a preset target value of pressure across said flow restrictor.

2. A system of mixing two or more fluid streams comprising in combination the fluid flow control system defined in claim 1, coupled to a mixer which is also coupled to a source of a second fluid.

3. The system defined in claim 1 including means for inputting a flow modifying signal to said controller or for modifying the control signal due to a change in the relationship between the pressure differential across the transducer versus the flow.

4. The system defined in claim 2 including means for inputting a flow modifying signal to said controller or for modifying the control signal due to a change in the relationship between the pressure differential across the transducer versus the flow.

5. A fluid flow control system for mixing fluids from two or more sources of fluid under pressure,
a first flow path for coupling one of said sources of a first fluid to a point of utilization,
a first valve in said first flow path,
a first flow restrictor in said flow path downstream of said valve.
a first pressure transducer connected across said first flow restrictor for measuring the pressure differential thereacross and producing a signal proportional to said pressure differential,
a controller connected to receive said signal and pulse said first valve at a frequency to obtain a preset target value of fluid pressure across said flow restrictor,
a first flow path coupling said flow restrictor to a fluid mixer,
said mixer coupled to a second fluid, the flow rate of which is controlled by a second flow control means.
means coupling said first flow path to said mixer, said mixer constituting said point of utilization.

6. The fluid flow control system defined in claim 3 wherein said second source includes a second flow path having a second valve, a second flow restrictor and a second pressure transducer controlling a second fluid, all connected and operating as in said first flow path, and means coupling said second flow path to said mixer.

7. The system defined in claim 5 including means for inputting a flow modifying signal to said controller.

8. The system defined in claim 6 including means for inputting a flow modifying signal to said controller.
